(19) United States
(12) Patent Application Publication
(10) Pub. No.: US 2014/0250765 A1
(43) Pub. Date: Sep. 11, 2014

(54) Quick Release Fishing Bobber

(71) Applicant: Kent W. Berchin-Miller, Peoria, AZ (US)

(72) Inventor: Kent W. Berchin-Miller, Peoria, AZ (US)

(21) Appl. No.: 14/185,890

(22) Filed: Feb. 20, 2014

Related U.S. Application Data
(60) Provisional application No. 61/851,507, filed on Mar. 9, 2013.

(51) Int. Cl. A01K 93/00

(52) U.S. Cl. CPC A01K 93/00
USPC 43/44.87

(57) ABSTRACT

The method of attaching a bobber to a fishing line is performed by using pressure applied to two elongated flat surfaces to pinch the line, and a method to tie a knot in the line so that there is a thicker portion of the line to apply the attaching pressure. When the fish is snagged on the hook, the line tension pulls the knot apart and only a single line thickness is left between the two pressure surfaces. This allows the line to slip between the two pressure surfaces, provided the pressure surfaces do not significantly close their gap when the knot is pulled out.

### CROSS REFERENCE TO RELATED APPLICATIONS

This application claims the benefit of U.S. Provisional Application No. 61/851,507, filed on Mar. 9, 2013. The entire provisional application is incorporated by reference herein.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

This invention is directed to fishing equipment, in particular, floats and bobbers attached to a fisherman's line to indicate whether or not a fish is hooked or nibbling at the bait on the end of a fishing line.

(2) Description of Related Art

In the sport of fishing, it is common to use a bobber which is attached to the fishing line at a point between the fishing rod and the lure used to attract fish. The lure can be bait on a hook, a metal lure, a plastic lure, or a fly that is used for fishing on the water surface or below the water surface. All bobbers include a floating piece and component(s) that allow attachment to a fishing line. A bobber serves primarily to give a visual indication of a fish taking the lure in its mouth, but is also used to suspend a lure at a specific water depth. It is used to give an indication of the quality of drag-free drift along a moving section of water. It can also be used to impart an undulating motion to a moving lure with a pull-pause retrieve. It can double as a lure when fashioned with a hook.

One type of bobber that is used also incorporates a lure, and the lure is made from a counterfeit dry fly that is fabricated to resemble a crippled insect trapped on the water surface. This increases the usefulness of bobbers by adding other functions.

Others have worked on bobbers and floats attached to a fishing line. Bobbers are useful to indicate several concerns for a fisherman. The bobber can be a general round shape or a cylinder shape because it is an easily viewed indicator of the hook condition. If a weight is used near the hook to provide tension between the hook and bobber, the bobber will have a normal ‘all is well’ indication by floating in a normal manner that makes it obvious to the fisherman that the hook is hanging freely and is not touching the bottom of the lake. If the hook/weight is resting on the bottom, the bobber will roll over partially, and this will indicate that the hook is not under tension and is likely resting on the bottom (or on other object in the lake).

If the hook is disturbed by a fish nibbling at the bait/lure by the hook, the bobber will bounce up and down slightly, indicating that a fish is nibbling/playing with the bait/lure. The bobber then becomes very useful for the fisherman as it indicates that he might be able to capture the fish by a sudden tug on the line to snag the hook in the fish's mouth.

If the fish is hooked and attempting to swim away, the bobber will most likely drop below the water surface, indicating that a fish is captured by a hook and is moving.

However, there can be a few issues with a bobber when it is attached to a fishing line. The bobber must be attached firm enough so that it will control the hook depth below the water surface; i.e., it must be attached tightly enough so that the line between the hook and lure is under tension. If the bobber is attached too loosely, the line will slide through the bobber and this will allow the hook to sink to the bottom of the lake.

Current types of bobbers have drawbacks. Bobbers which are permanently attached to the fishing line are useful for fishing in shallow water, but are less useful when fishing in deeper water because the fish hook may need to be set at a greater depth. A long distance between the hook and bobber makes it difficult to cast the line.

A common style of bobber attachment device is a hoop attached to the underside of the float. The fisherman chooses the location on the fishing line to place the bobber, and then must thread a tightly pinched loop of fishing line through the hoop. The loop is then wrapped back around over the float, and pulled tight to secure it in place. The downside is that after fishing a short period of time, the fishing line, being made of a polymer material, retains memory of the tight radius turns it goes through being attached the bobber. So, when the bobber is either adjusted, or removed, the fishing line is no longer straight, and care must be taken to straighten the line back out by using heat and/or tension. This takes time, and often weakens the fishing line. Furthermore, repositioning the bobber to another location on the fishing line takes a significant amount of time compared to other types of attachment devices.

Another style of bobber uses a peg to pinch the fishing line against a portion of the float. Typically, the float has a hole through its center of an appropriate diameter to accommodate the fishing line and the peg. The peg is tapered so that when it is co-inserted into the hole, it can handle a wide range in fishing line diameters. To attach the bobber, the end of the fishing line is threaded through the hole, and the bobber is moved along the fishing line to the location it is to be secured. The peg is then inserted with enough force to pinch the fishing line against the inside diameter of the hole. The bobber position is adjustable by removing the peg, sliding the bobber to another location, and reinserting the peg.

There are several disadvantages to this design. First of all, the bobber must be threaded before any lures can be tied to the fishing line, and to remove the bobber, the lures must be cut free. Secondly, the peg is likely to loosen causing the bobber to slide along the fishing line. Thirdly, the hole through the float becomes worn over time reducing the efficacy of peg grip. Finally, the peg is prone to becoming lost by dropping it in the water.

Another style of bobber has three pieces: two foam bodies that align together and a rubber tensioner which holds them together. The foam bodies fit together via a slot that runs down their central axis in a longitudinal direction. A dog-bone shaped tensioner secures the two foam bodies together by inserting it into a slot, and then the dog-bone ends are pulled to the ends of the foam bodies. To secure the bobber to the fishing line, the line is inserted into the slot so that it is in contact with the tensioner. The foam bodies are separated, and the force of the tensioner wants to push the foam bodies together. The foam bodies are counter rotated several times to twist the rubber tensioner which causes it to grab the fishing line. Additional rotations result in a tighter grip on the fishing line.

An advantage of this design is that it allows the bobber to be attached and removed without having to remove lures. It also does not kink the fishing line. A distinct disadvantage however, is that the rubber tensioner eventually wears out, or breaks, which reduces the life of the bobber. Another disadvantage is that removing the bobber requires the same number of counter-rotations that were used to secure the bobber, but in the opposite direction, and that number is difficult to remember.

The bobber may be colored so as to facilitate easy recognition of the hook condition. If a round bobber is colored with a red lower half and a white upper half, so that the red portion is under water when the fishing line is under tension between the hook and bobber, it is easy to recognize the condition of the hook. An all-white appearance of the bobber indicates that there is tension on the hook. A white bobber that is disturbed will indicate that a fish in playing with the bait/hook. A bobber that is partially red and partially white will indicate lack of tension to the hook and the hook is likely resting on the bottom.

U.S. Pat. No. 8,341,872 is an example of improving the method of attaching the bobber to the fishing line. However, its use is restricted because the magnet that is permanently attached to the fishing line will cause winding difficulties on the reel which winds up the fishing line.

U.S. Pat. No. 7,437,850 is another example of working on the slip/attachment method. However it is difficult to reliably cast the line without activating the release mechanism.

What is lacking in the art is a reliable way to attach the bobber to the fishing line, yet allow the bobber to slide on the line when reeling the fish in. If the hook is a long distance underneath the bobber and the bobber is too firmly attached, the hook will hang too far down from the fishing rod making it difficult for a fisherman to catch fish. It is an unreliable method for a fisherman to actually pull the fish out of the water with the line and allow the fish to hang underneath the hook. A hook that is not well set in the fish's mouth may allow the fish to wiggle off the hook. It is a better method to bring the fish close to the fisherman and use a net to lift it out of the water, particularly when catching large fish.

What is desired in a bobber is an improved method to firmly attach it to a fishing line, yet slide on the line when reeling a fish in. Additionally, the attachment must allow the line to be undamaged.

### BRIEF SUMMARY OF THE INVENTION

The method of attaching a bobber to a fishing line is performed by using pressure applied to two elongated flat surfaces to pinch the line, and a method to tie a knot in the line so that there is a thicker portion of the line to apply the attaching pressure. When the fish is snagged on the hook, the line tension pulls the knot apart and only a single line thickness is left between the two pressure surfaces. This allows the line to slip between the two pressure surfaces, provided the pressure surfaces do not significantly close their gap when the knot is pulled out.

### BRIEF DESCRIPTION OF THE SEVERAL VIEWS OF THE DRAWING(S)

FIGS. 1A-1B show a picture of a standard bobber with a spring applied hook to attach to the fishing line. A front view and side view is shown.

FIG. 2 shows an improved bobber with a nut that is used to apply the pressure to the fishing line knot.

FIG. 3 is a design of the knot used in the fishing line.

FIG. 4 shows the assembled bobber according to a preferred embodiment in a front and side view.

FIG. 5A-5C are details of additional embodiments.

FIG. 6 shows how a slip knot is made in the fishing line without the need to make the knot prior to threading the line through the bobber.

FIG. 7 is a view of the fishing line, weight, hook, and bobber used when fishing from a boat.

FIG. 8 is another embodied slip knot.

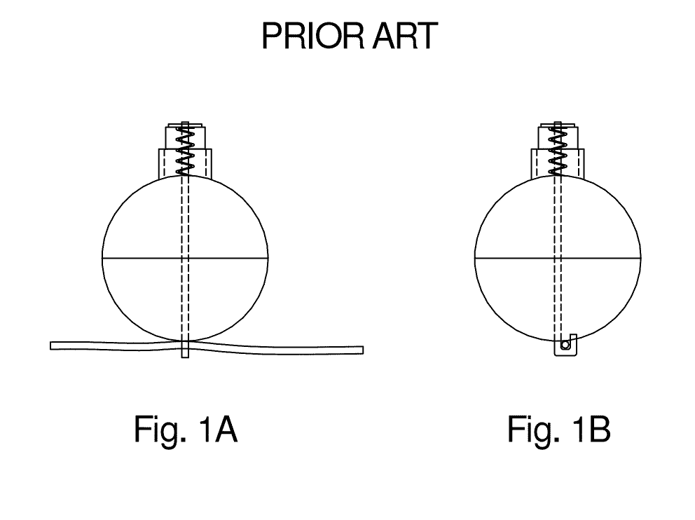

### DETAILED DESCRIPTION OF THE INVENTION

An object of this invention is to provide a fishing line bobber primarily designed for use in fly fishing. It comprises a float, a line attachment device, and a slip knot. The combination of the line attachment device, float, and slip knot provides a highly functional bobber. The line attachment device includes two pressure surfaces that attach the bobber to the fishing line leader. The attachment device provides easy attachment and removal of the bobber on the fishing line as well as convenient position adjustment. The two pressure surfaces are applied against the fishing line by screwing a nut on a slotted male threaded post.

To prevent the line from being cut when the nut is tightened against the knot, the slot on the threaded post must extend deep enough to match the second pressure surface. If the slot is too shallow, the line will be cut by tightening the nut due to the shear action of the nut against the line and the edges of the slot.

To prevent the loss of the nut in the event it is completely unscrewed, a leash is used to keep the nut attached to the bobber. The leash is designed so as to allow screwing the nut onto the male threaded post. By twisting the nut by hand, the nut is used to apply more, or less, pressure to the fishing line so as to facilitate the bobber's functionality.

In one preferred embodiment, the bobber is arranged on the fishing line via a quick release function. The bobber is first connected to the fishing line, and when a fish is hooked the fishing line tension causes the bobber to disengage from the fishing line so as to allow it to slip on the fishing line. This capability is extremely useful when a fisherman uses the bobber to suspend his bait lure at a depth under water greater than the length of the rod he is using. In such an instance, without quick release capability, the position of the bobber will prevent the fisherman from being able to bring the fish close enough to be taken by hand or net. This is because bobbers are almost always too big to fit through the guides of the rod, which limits how close a hooked fish can be brought in with the rod to be taken.

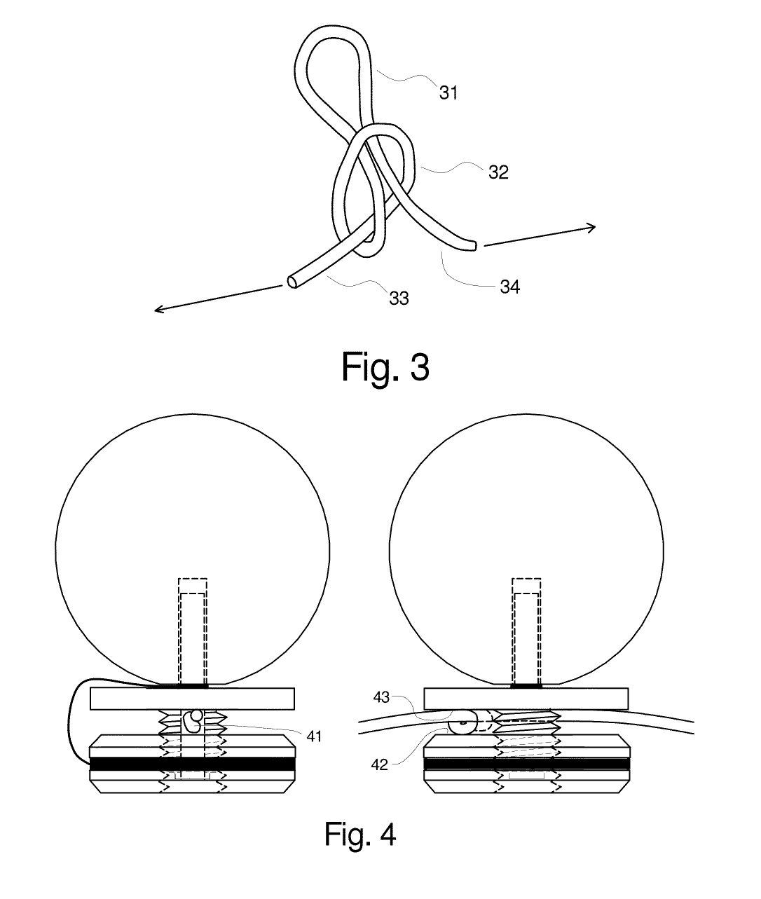

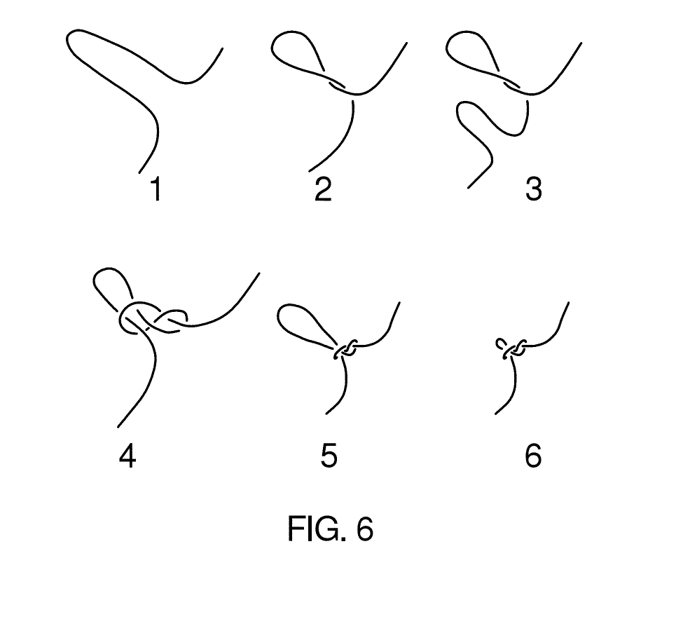

To facilitate the quick release function, a slip knot is tied into the fishing line at the desired position where the bobber will be placed. Referring to FIG. 3, the knot comprises a loop 31, an overhand knot portion 32 encircling the loop, and two fishing line ends 33 and 34 extending away from it. The overhand knot portion 32 is pulled tight. (Also see FIG. 6). Then the loop 31 of the slip knot is carefully drawn down to a very small loop by pulling on the fishing line so that the entire knot is positioned between the pressure surfaces of the bobber. An un-knotted portion of the fishing line adjacent to the knot also fits in between the two pressure surfaces and runs through it. In this manner, the bobber is loosely attached to the fishing line by entrapping the fishing line within the boundaries of the slot and nut.

The slip knot 41 effectively doubles or triples the thickness of fishing line clamped between the two pressure surfaces 42, 43 when the nut is tightened as illustrated in FIG. 4. One pressure surface 42 is on the outside flat surface of the nut, as illustrated, and the other pressure surface 43 is on a surface immediately adjacent to the slot. The surface 43 is flat ring surface in FIG. 4, but other surfaces geometries are envisioned, such as a rectangular surface immediately adjacent to the slot. When a fish is hooked, the fishing line tension pulls the knot apart so that only a single thickness remains between the pressure surfaces. The pressure surfaces no longer clamp down on the fishing line. The bobber is then free to slide along the fishing line without becoming detached, and a fish can be brought in sufficiently close to be taken by hand or net. The clamping force is adjusted so that the knot is not hindered from pulling apart.

The bobbers described in this invention are most useful for fly fishing, especially when a bobber is used for sub-surface flies. This style of fly fishing requires frequent adjustments of the bobber along the fishing line to present the lures at the ideal fishing depth.

This bobber design provides fast and easy adjustment along the fishing line without imparting any severe kink or deformity in the fishing line. Also, once it is secured at the desired position, it stays firmly in place without sliding along the fishing line during casting or other lure presentations.

Materials:

The bobber components (i.e. the float and line attachment device) are preferably made from a polymer material (i.e. plastic) to reduce weight, but can also be fabricated from metal, wood, ceramic or composite materials as well. Plastics well suited to the bobber assembly are polypropylene, polyethylene, and nylon, due to their toughness, processing qualities and cost. In another embodiment, the bobber parts are a mix of different materials.

To state it more specifically, typical plastic materials contemplated for this invention are nylon 6/6, ultra-high molecular weight (UHMW) polyethylene, and polypropylene, with the preferred material being nylon 6/6. Nylon 6/6 provides a good balance of strength, toughness, and processing options. The leash can be made out of any higher strength material such as Kevlar thread, gel-spun thread, or monofilament. The float can be made from materials that include various closed cell foams, cork, and polypropylene yarn, so long as the function of floating on the water is maintained. The float is designed with a defined shape so that its overall density is less dense than water by using a material density is lighter than water, or incorporating an air space so that it will float. A suitable floatation device would be air entrapped inside a spherical shape. In other embodiments, natural looking shapes are used for the float that include grasshoppers, ants, stoneflies, worms, and the like. These kinds of shapes will lure a fish to the surface, and is desirable for certain kinds of fishing including fly fishing.

Fabrication Methods:

The bobber parts are preferably fabricated by heating a thermoplastic, or by machining. Injection molding is especially well suited to the fabrication of bobber parts. The float can be fabricated by mold casting, injection molding, or by machining harder foam materials. Parts are assembled by gluing them together with an appropriate adhesive. The preferred adhesives include gel-type cyanoacrylates such as Loctite™ Ultra Gel Control Super Glue.

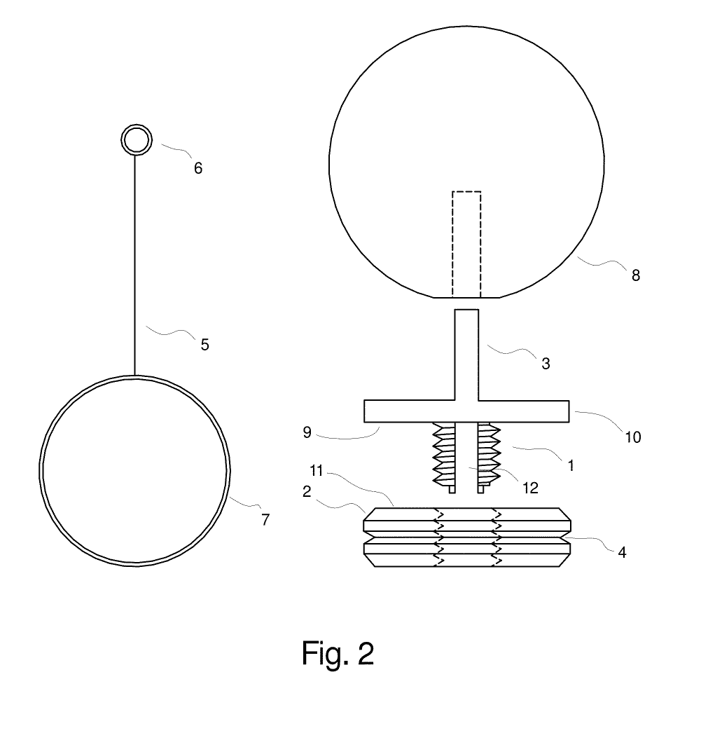

FIG. 2 shows a bobber in an exploded view. Male threads 1 with a slotted cavity 12 are attached to a base 10 and an attaching post 3. A nut 2 is used to screw on the male threads and apply pressure to the fishing line by use of an upper pressure surface 9 adjacent to the slot and a lower pressure surface 11 on the flat outer surface of the nut. A leash 5 is used to keep the nut 2 from being lost, and is attached to the bobber by use of a small leash hoop 6 and a large leash hoop 7. The small leash hoop is connected to the attaching post and the large leash hoop is connected to the nut 2 by use of a leash hoop recess 4. The float 8 has a cavity to receive the attachment post 3 which is rigidly connected to the float 8 by glue or other permanent connecting means.

Detailed Example of an Embodied Part Fabrication:

The male threads with a slotted cavity is made from a ¼ inch long slotted nylon set screw with an 8-32 thread pitch. The slot is extended ⅛ inches by using a saw. The base and attaching post are machined from ⅜ inch diameter nylon 6/6 rod. The attachment post is about 1/16 inch diameter and ¼ inch long. The base is ⅜ inch diameter and about ⅛ inch thick. A hole is drilled into the base to glue the slotted component in place. The nut is machined from a ⅜ inch diameter nylon 6/6 rod, and tapped with an 8-32 female thread. The leash hoop recess is about 1/32 inch deep with a rounded cross-section. The leash is made from gel-spun polypropylene thread. The float is a Smooth Foam™ ball, between ½ inch and 1½ inch diameter inclusive. A small amount of foam is shaved from the ball surface to create a flat surface for the attaching post. The attaching post hole and flat portion on the foam ball are coated with Loctite Ultra Gel Control Super Glue and then the attachment post is inserted into the hole for bonding. The bobber is finished and ready for fishing when the glue cures.

FIG. 3 is an illustration of the slip knot used on the fishing line. Both fishing line ends 33, 34 are pulled together and a first loop 31 is made. Then fishing line end 33 is pulled toward the loop and another overhand knot 32 is made. Both ends are then pulled apart (as illustrated) which tightens the knot and reduces the size to a very small volume. The tension in the fishing line becomes a good guide to when the knot has tightened up completely, and additional pulling will cause the knot to become ‘undone.’ After a little practice, the required amount of tightening is easily found by feel. Also the amount of pressure needed on the knot by tightening the nut is found by feel.

FIG. 4 is an assembly of the parts of the bobber. The fishing line 41 trapped between the pressure surface is shown a double thickness for the sake of a clean illustration. However, in practice the knot is tightly made and is also folded over at various angles.

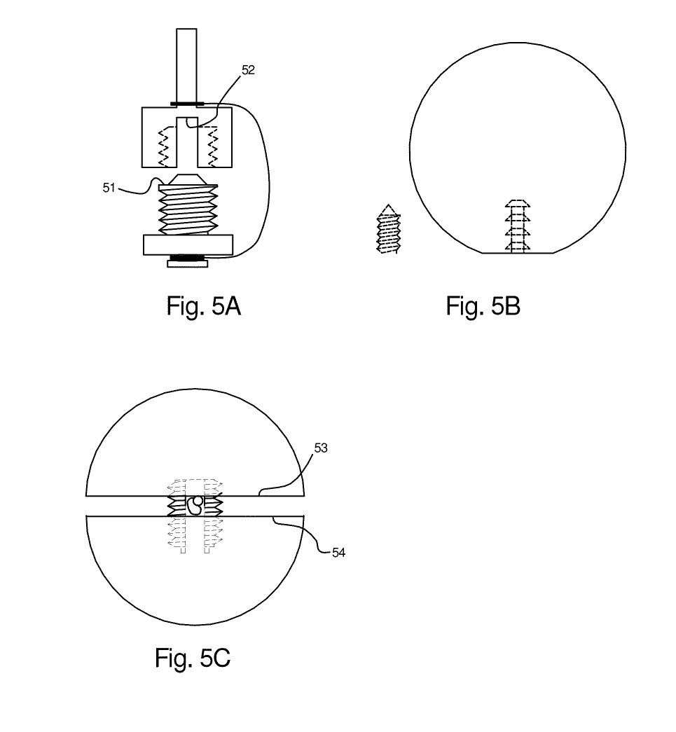

FIG. 5 shows illustration of various alternative designs. FIG. 5A is an alternate embodiment for the leash, pressure surfaces 51, 52, and the method to create clamping pressure. FIG. 5B is another embodied design where the attachment post is a barb or a threaded post. FIG. 5C is an embodied design where the float incorporates a slotted, threaded shaft and twisting the float halves puts clamping pressure on the fishing line by using two pressure surfaces 53,54 on the inside flat surface of the float halves.

FIG. 6 shows how a slip knot is made is made in the fishing line in six steps by looping and twisting the fishing line. As is easily seen, there is no need to make the knot prior to threading the line through the bobber. FIG. 8 shows another embodied slip knot that does not use an overhand knot. In this case, the slip knot is formed by looping the fishing line, and tightening the knot under pressure from the two pressure surfaces.

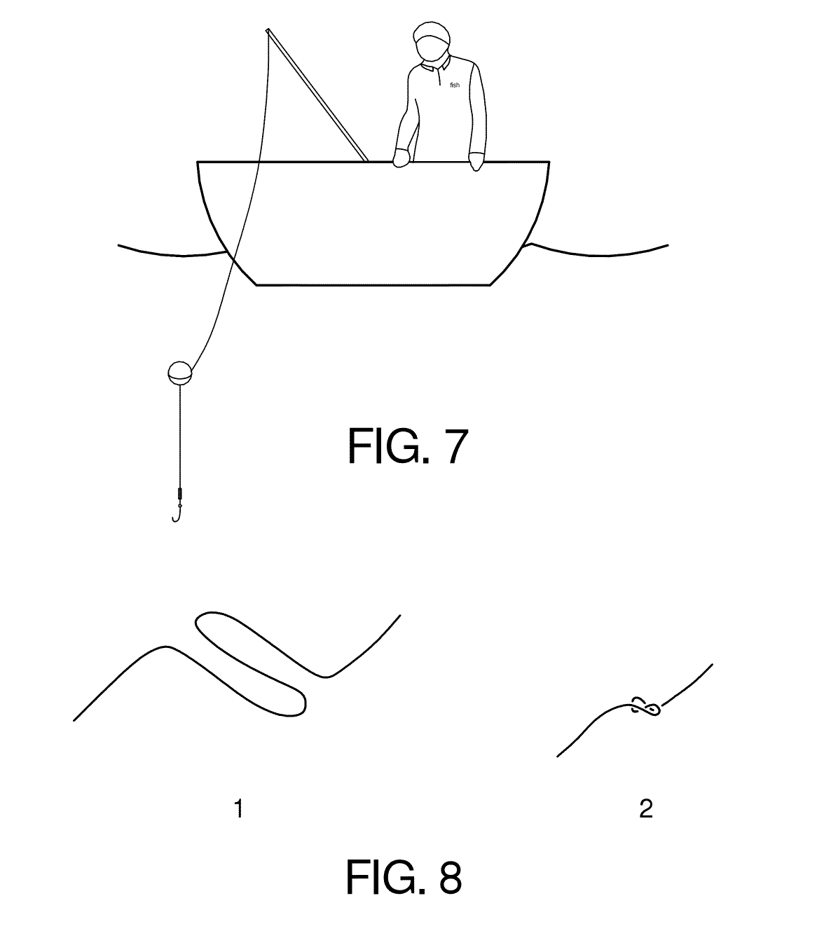

FIG. 7 is view of the fishing line, weight, hook, and bobber used when fishing from a boat.

While various embodiments of the present invention have been described, the invention may be modified and adapted to various operational methods to those skilled in the art. Therefore, this invention is not limited to the description and Fig. shown herein, and includes all such embodiments, changes, and modifications that are encompassed by the scope of the claims.

I claim:

1. A method for attaching a bobber to a fishing line comprising:
a) providing a float comprising:
1) a defined shape with an overall density less than water,
b) providing a line attachment device comprising:
1) a threaded post with a slot,
2) a nut which screws onto said threaded post,
3) a first pressure surface adjacent to said slot,
4) wherein the depth of said slot on said threaded post extends to at least said first pressure surface,
5) wherein said threaded post is attached to said float, and
6) wherein a second pressure surface is on the flat portion of said nut that faces said float,
c) tying a slip knot on said fishing line at a desired location,
d) placing said slip knot between said first pressure surface and said second pressure surface, and
f) rotating said nut to create a force to be applied by said second pressure surface on said slip knot,
whereby said bobber is attached to said fishing line at said desired location.

2. The method for attaching a bobber to a fishing line according to claim 1 wherein said float is a shape that will lure fish.

3. The method for attaching a bobber to a fishing line according to claim 1 wherein said threaded post is attached to said float by use of an attaching post.

4. The method for attaching a bobber to a fishing line according to claim 1 wherein a leash is used to connect said nut to said line attachment device.

5. The method for attaching a bobber to a fishing line according to claim 1 wherein said slip knot pulls out when a fish is hooked on said fishing line, and said bobber remains loosely attached to said fishing line.
